(19) United States
(12) Patent Application Publication
(10) Pub. No.: US 2024/0337672 A1
(43) Pub. Date: Oct. 10, 2024

(54) REAL-TIME SHORT-SAMPLE ASPIRATION FAULT DETECTION

(71) Applicant: Siemens Healthcare Diagnostics Inc., Tarrytown, NY (US)

(72) Inventor: Narayanan Ramakrishnan, New City, NY (US)

(73) Assignee: Siemens Healthcare Diagnostics Inc., Tarrytown, NY (US)

(21) Appl. No.: 18/579,319

(22) PCT Filed: Jul. 12, 2022
(86) PCT No.: PCT/US2022/073657

§ 371 Date: Jan. 12, 2024

Related U.S. Application Data
(60) Provisional application No. 63/221,453, filed on Jul. 13, 2021.

(51) Int. Cl. G01N 35/00; G01F 22/02; G01N 35/10

(52) U.S. Cl. CPC G01N 35/00623; G01F 22/02; G01N 35/1009

(57) ABSTRACT

Methods of real-time detection of short-sample aspiration faults in an automated diagnostic analysis system include spectral analysis of a pressure slope waveform based on aspiration pressure measurement signals. The spectral analysis may include using a moving average filter or a wavelet transform, such as, e.g., a continuous wavelet transform (CWT) or a discrete wavelet transform (DWT), to identify distinct transient behavior in the pressure slope waveform. These methods accurately identify short-sample aspiration faults such that an automated diagnostic analysis system can timely terminate an analysis of a detected short sample to avoid a possibly erroneous sample test result. Apparatus for real-time detection of short-sample aspiration faults is also provided, as are other aspects.

### CROSS REFERENCE TO RELATED APPLICATION

This application claims the benefit of U.S. Provisional Patent Application No. 63/221,453, entitled “REAL-TIME SHORT-SAMPLE ASPIRATION FAULT DETECTION” filed Jul. 13, 2021, the disclosure of which is hereby incorporated by reference in its entirety for all purposes.

### FIELD

This disclosure relates to aspiration of liquids in automated diagnostic analysis systems.

### BACKGROUND

In medical testing, automated diagnostic analysis systems may be used to analyze a biological sample to identify an analyte or other constituent in the sample. The biological sample may be, e.g., urine, whole blood, blood serum, blood plasma, interstitial liquid, cerebrospinal liquid, and the like. Such biological liquid samples are usually contained in sample containers (e.g., test tubes, vials, etc.) and may be transported via container carriers and automated tracks to and from various imaging, processing, and analyzer stations within an automated diagnostic analysis system.

Automated diagnostic analysis systems typically include automated aspirating and dispensing apparatus, which is configured to aspirate (draw in) a liquid from a liquid container (e.g., a sample of a biological liquid or a liquid reagent, acid, or base to be mixed with the sample) and dispense the liquid into a reaction vessel (e.g., a cuvette). The aspirating and dispensing apparatus typically includes a probe (e.g., a pipette) mounted on a moveable robotic arm or other automated mechanism that performs the aspiration and dispensing functions and transfers the sample or reagent to the reaction vessel.

During the aspiration process, the moveable robotic arm, which may be controlled by a system controller or processor, may position the probe above a liquid container and then lower the probe into the container until the probe is partially immersed in the liquid. A pump or other aspirating device is then activated to aspirate (draw in) a portion of the liquid from the container into the interior of the probe. The probe is then withdrawn from the container such that the liquid may be transferred to and dispensed into a reaction vessel for processing and/or analysis. During or after the aspiration, an aspiration pressure signal may be analyzed to determine whether any anomalies occurred, such as, e.g., aspiration of an insufficient amount of liquid, which may be referred to hereinafter as a short-sample aspiration fault.

While conventional systems may be able to detect some short-sample aspiration faults, such detection may not be accurate, may incur high computational costs, and/or may occur too late in the sample analysis process to prevent a short sample from adversely affecting testing results.

Accordingly, there is a need for improved methods and apparatus for accurate real-time detection of short-sample aspiration faults so as to avoid erroneous or inaccurate sample testing.

### SUMMARY

In some embodiments, a method of detecting a short-sample aspiration fault in an automated diagnostic analysis system is provided. The method includes performing aspiration pressure measurements via a pressure sensor as a liquid is being aspirated in the automated diagnostic analysis system. The method further includes analyzing an aspiration pressure measurement signal waveform via a processor executing an algorithm. The algorithm is configured to derive a slope waveform from the aspiration pressure measurement signal waveform and to compute a moving average of the slope waveform, or compute a wavelet transform of the slope waveform. The method further includes identifying and responding to a short-sample aspiration fault via the processor in response to the analyzing.

In some embodiments, an automated aspirating and dispensing apparatus is provided that includes a robotic arm, a probe coupled to the robotic arm, a pump coupled to the probe, a pressure sensor configured to perform aspiration pressure measurements as a liquid is being aspirated via the probe, and a processor configured to execute an algorithm to detect and respond to a short-sample aspiration fault during an aspiration process. The algorithm is configured to analyze an aspiration pressure measurement signal waveform received from the pressure sensor by deriving a slope waveform from the aspiration pressure measurement signal waveform and performing a spectral analysis of the slope waveform by computing a moving average or a wavelet transform of the slope waveform.

In some embodiments, a non-transitory computer-readable storage medium includes a processor-executable algorithm configured to detect a short-sample aspiration fault based on spectral analysis of a pressure slope waveform derived from an aspiration pressure measurement signal waveform. The algorithm is configured to perform the spectral analysis of the pressure slope waveform by computing a moving average or a wavelet transform of the pressure slope waveform.

In some embodiments, a method of detecting a short-sample aspiration fault in an automated diagnostic analysis system is provided. The method includes deriving an aspiration pressure measurement signal waveform from aspiration pressure measurements made by a pressure sensor as a liquid is being aspirated in the automated diagnostic analysis system. The method also includes identifying a pattern in one or more first aspiration pressure measurement signal waveforms of normal aspirations and defining a time-windowed localization of an aberration identified in one or more second aspiration pressure measurement signal waveforms, wherein the aberration is caused by the short-sample aspiration fault. The method further includes deriving suitable discriminating metrics to detect the aberration, wherein simple thresholding, an unsupervised classifier, or a supervised learning-based classifier is used with the discriminating metrics to identify the aberration in subsequent aspiration pressure measurement signal waveforms.

Still other aspects, features, and advantages of this disclosure may be readily apparent from the following detailed description and illustration of a number of example embodiments and implementations, including the best mode contemplated for carrying out the invention. This disclosure may also be capable of other and different embodiments, and its several details may be modified in various respects, all without departing from the scope of the invention. For example, although the description below relates to automated diagnostic analysis systems, the short-sample aspiration fault detection methods and apparatus disclosed herein may be readily adapted to other automated systems that would benefit from accurate real-time detection of short-sample aspiration faults. This disclosure is intended to cover all modifications, equivalents, and alternatives falling within the scope of the appended claims (see further below).

### BRIEF DESCRIPTION OF DRAWINGS

The drawings, described below, are for illustrative purposes and are not necessarily drawn to scale. Accordingly, the drawings and descriptions are to be regarded as illustrative in nature, and not as restrictive. The drawings are not intended to limit the scope of the invention in any way.

FIG. 1 illustrates a top schematic view of an automated diagnostic analysis system configured to analyze biological samples according to embodiments provided herein.

FIGS. 2A and 2B each illustrate a front view of a sample container according to embodiments provided herein.

FIG. 3 illustrates a front schematic view of aspirating and dispensing apparatus according to embodiments provided herein.

FIG. 4 illustrates a flowchart of a method of detecting a short-sample aspiration fault in an automated diagnostic analysis system according to embodiments provided herein.

FIG. 5A illustrates a graph of an aspiration pressure signal waveform versus time of a normal aspiration according to embodiments provided herein.

FIG. 5B illustrates a graph of an aspiration pressure slope waveform versus time of the aspiration pressure signal waveform of FIG. 5A according to embodiments provided herein.

FIG. 6A illustrates a graph of an aspiration pressure signal waveform versus time of an abnormal aspiration (short-sample aspiration fault) according to embodiments provided herein.

FIG. 6B illustrates a graph of an aspiration pressure slope waveform versus time of the aspiration pressure signal waveform of FIG. 6A according to embodiments provided herein.

FIG. 7A illustrates a graph of a moving average (MA) of a slope waveform representing normal aspiration according to embodiments provided herein.

FIG. 7B illustrates a graph of delta signals based on the moving average (MA) of FIG. 7A according to embodiments provided herein.

FIG. 8A illustrates a graph of a moving average (MA) of a slope waveform representing abnormal aspiration according to embodiments provided herein.

FIG. 8B illustrates a graph of delta signals based on the moving average (MA) of FIG. 8A according to embodiments provided herein.

FIG. 9 illustrates a graph of a plurality of delta signals based on the moving average (MA) of eight sample aspiration pressure signal waveforms according to embodiments provided herein.

FIG. 10 illustrates a bar graph of signal-to-noise ratio (SNR) versus SNR metrics for the FIG. 9 delta signals of the eight-sample aspiration pressure signal waveforms according to embodiments provided herein.

FIG. 11 illustrates a graph of pressure slope versus time of eight test sample aspiration pressure signal waveforms according to embodiments provided herein.

FIG. 12 illustrates a graph of a two-cluster classification of a maximum slope metric of the eight-test sample aspiration pressure signal waveforms of FIG. 11 according to embodiments provided herein.

FIG. 13 illustrates a graph of SNR metrics versus time for a normal aspiration sample based on a continuous wavelet transform (CWT) according to embodiments provided herein.

FIG. 14 illustrates a graph of SNR metrics versus time for an abnormal aspiration sample based on a CWT according to embodiments provided herein.

FIG. 15 illustrates a graph of SNR metrics versus time for a normal aspiration sample based on a discrete wavelet transform (DWT) according to embodiments provided herein.

FIG. 16 illustrates a graph of SNR metrics versus time for an abnormal aspiration sample based on a DWT according to embodiments provided herein.

FIG. 17 illustrates a schematic of a multi-level discrete wavelet transform (DWT) filter bank according to embodiments provided herein.

### DETAILED DESCRIPTION

Embodiments described herein provide methods and apparatus to timely and accurately detect, in real-time, a short-sample aspiration fault. A short-sample aspiration fault occurs when an aspiration fails to draw a sufficient volume of liquid, which may be caused by, e.g., a liquid container with an insufficient volume of liquid, a blockage, and/or defective equipment (e.g., a defective aspiration pump, a defective robotic arm improperly positioning a probe within a liquid container, defective software, etc.). In some embodiments, a short sample may be considered less than 92 μL for a nominal/target aspiration volume of 100 μL. Other volumes may be considered a short sample. Timely and accurate real-time detection of a short-sample aspiration fault may enable an automated diagnostic analysis system to terminate an analysis of the sample and/or implement a suitable error state procedure to advantageously avoid erroneous analysis results. In some embodiments, detection of a short-sample aspiration fault may be considered timely if detected during or immediately after completion of an aspiration process.

In accordance with one or more embodiments, timely and accurate real-time detection of short-sample aspiration faults may be implemented via a software or firmware algorithm executing on a system controller, processor, or other like computer device of an automated diagnostic analysis system or an automated aspirating and dispensing apparatus. In some embodiments, the algorithm may be a learning-based AI (artificial intelligence) algorithm. The algorithm may be configured to perform a spectral analysis of a pressure slope waveform derived from aspiration pressure measurement signals provided by a pressure sensor to identify distinct transient behavior in the pressure slope waveform. The spectral analysis may include a time-domain analysis, such as a moving average filter analysis or an analysis of a band-pass filtered signal, or the spectral analysis may use a Short-Time Fast Fourier Transform (STFT) or a wavelet transform analysis. Preferred embodiments may include a moving average filter analysis because of its simplicity, or a wavelet transform analysis because of its ability to localize in time and scale (spectral content).

The moving average filter analysis may include computing a difference between a moving average (determined over a suitable moving average window) and the slope waveform at suitable time steps within a suitable detection window of the slope waveform during the aspiration process. A suitable signal-to-noise ratio (SNR) threshold may then be applied to the computed differences to classify the aspiration as normal or abnormal.

The discriminating signal metrics may be one or more of the following: (a) some statistical measure such as max, median, standard deviation, 75^{th} percentile value, etc., of the pressure slope in a pre-determined time-window of interest, or (b) difference between the pressure slope and a moving average of pressure slope in a pre-determined time-window of interest.

The wavelet transform analysis may include using a continuous wavelet transform (CWT) or a discrete wavelet transform (DWT), interrogating metrics based on the transform coefficients in a specific range of scales, and then applying suitable SNR thresholds for classification of the aspiration as normal or abnormal.

More advanced learning-based classifiers may be used to automatically set thresholds or discriminating boundaries separating abnormal (short-sample aspirations) from normal aspirations in a robust manner to achieve high classification accuracy. In some embodiments, k-means clustering may be used to classify the aspiration as normal or abnormal in an unsupervised manner based on the SNR metrics. A simple thresholding-based fuzzy classifier or simple rule-based criteria or schema can also be used alternatively to classify the samples as normal or abnormal (short-sample aspiration). Supervised learning-based classifiers such as logistic function classifiers or Support Vector Machines may also be used.

Advantageously, both the moving average filter analysis and the wavelet transform analysis can be implemented online and in real-time during an aspiration process. Each online analysis has low computational complexity (O (N)) and low memory requirements and, thus, can be easily implemented in firmware or software.

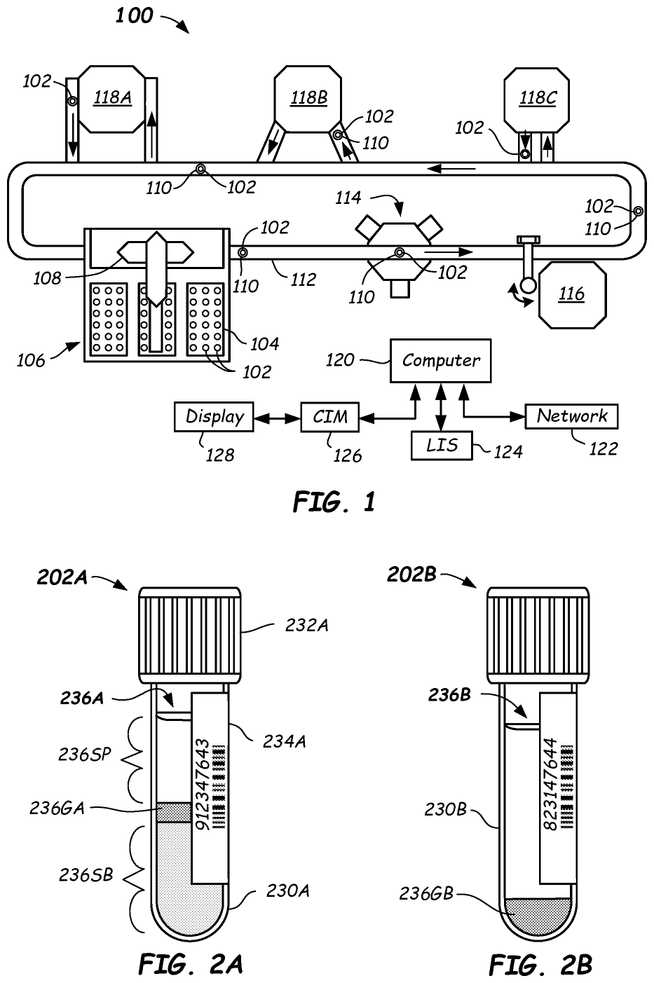

In accordance with one or more embodiments, methods and apparatus for timely and accurate real-time detection of short-sample aspiration faults will be explained in greater detail below in connection with FIGS. 1-17.

FIG. 1 illustrates an automated diagnostic analysis system 100 according to one or more embodiments. Automated diagnostic analysis system 100 may be configured to automatically process and/or analyze biological samples contained in sample containers 102. Sample containers 102 may be received at system 100 in one or more racks 104 provided at a loading area 106. A robotic container handler 108 may be provided at loading area 106 to grasp a sample container 102 from one of racks 104 and load the sample container 102 into a container carrier 110 positioned on an automated track 112. Sample containers 102 may be transported throughout system 100 via automated track 112 to, e.g., a quality check station 114, an aspirating and dispensing station 116, and/or one or more analyzer stations 118A-C.

Quality check station 114 may prescreen a biological sample for interferents or other undesirable characteristics to determine whether the sample is suitable for analysis. After successful prescreening, the biological liquid sample may be mixed with a liquid reagent, acid, base, or other solution at aspirating and dispensing station 116 to enable and/or facilitate analysis of the sample at one or more analyzer stations 118A-C. Analyzer stations 118A-C may analyze the sample for the presence, amount, or functional activity of a target entity (an analyte), such as, e.g., DNA or RNA. Other analytes commonly tested for may include enzymes, substrates, electrolytes, specific proteins, abused drugs, and therapeutic drugs. More or less numbers of analyzer stations 118A-C may be used in system 100, and system 100 may include other stations (not shown).

Automated diagnostic analysis system 100 may also include a computer 120 or, alternatively, may be configured to communicate remotely with an external computer 120. Computer 120 may be, e.g., a system controller or the like, and may have a microprocessor-based central processing unit (CPU) and/or other suitable computer processor(s). Computer 120 may include suitable memory, software, electronics, and/or device drivers for operating and/or controlling the various components of system 100 (including quality check station 114, aspirating and dispensing station 116, and analyzer stations 118A-C). For example, computer 120 may control movement of carriers 110 to and from loading area 106, about track 112, to and from quality check station 114, aspirating and dispensing station 116, and analyzer stations 118A-C, and to and from other stations and/or components of system 100. One or more of quality check station 114, aspirating and dispensing station 116, and analyzer stations 118A-C may be directly coupled to computer 120 or in communication with computer 120 through a network 122, such as a local area network (LAN), wide area network (WAN), or other suitable communication network, including wired and wireless networks. Computer 120 may be housed as part of system 100 or may be remote therefrom.

In some embodiments, computer 120 may be coupled to a laboratory information system (LIS) database 124. LIS database 124 may include, e.g., patient information, tests to be performed on a biological sample, the time and date the biological sample was obtained, medical facility information, and/or tracking and routing information. Other information may also be included.

Computer 120 may be coupled to a computer interface module (CIM) 126. CIM 126 and/or computer 120 may be coupled to a display 128, which may include a graphical user interface. CIM 126, in conjunction with display 128, enables a user to access a variety of control and status display screens and to input data into computer 120. These control and status display screens may display and enable control of some or all aspects of quality check station 114, aspirating and dispensing station 116, and analyzer stations 118A-C for prescreening, preparing, and analyzing biological samples in sample containers 102. CIM 126 may be used to facilitate interactions between a user and system 100. Display 128 may be used to display a menu including icons, scroll bars, boxes, and buttons through which a user (e.g., a system operator) may interface with system 100. The menu may include a number of functional elements programmed to display and/or operate functional aspects of system 100.

FIGS. 2A and 2B illustrate sample containers 202A and 202B, respectively, which are each representative of a sample container 102 of FIG. 1. Sample containers 202A and 202B may be any suitable liquid container, including transparent or translucent containers, such as blood collection tubes, test tubes, sample cups, cuvettes, or other containers capable of containing and allowing the biological samples therein to be prescreened, processed (e.g., aspirated), and analyzed. As shown in FIG. 2A, sample container 202A may include a tube 230A and a cap 232A. Tube 230A may include a label 234A thereon that may indicate patient, sample, and/or testing information in the form of a barcode, alphabetic characters, numeric characters, or combinations thereof. Tube 230A may contain therein a biological sample 236A, which may include a serum or plasma portion 236SP, a settled blood portion 236SB, and a gel separator 216GA located there between. As shown in FIG. 2B, sample container 202B, which may be structurally identical to sample container 202A, may contain therein a homogeneous biological sample 236B, wherein tube 230B has a gel bottom 236 GB.

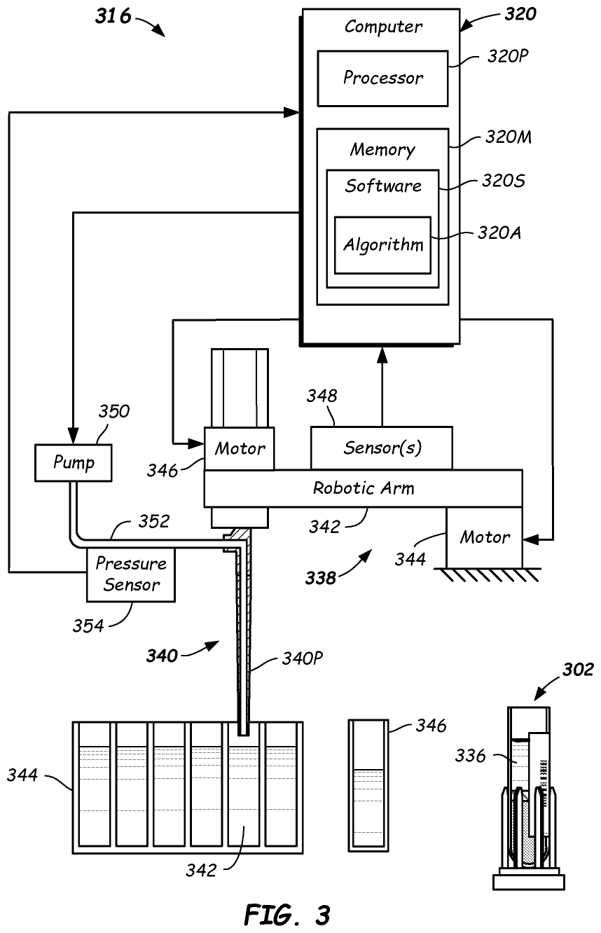

FIG. 3 illustrates an aspirating and dispensing apparatus 316 according to one or more embodiments. Aspirating and dispensing apparatus 316 may be part of, or representative of, aspirating and dispensing station 116 of automated diagnostic analysis system 100. Note that the methods and apparatus described herein for detecting a short-sample aspiration fault may be used with other embodiments of aspirating and dispensing apparatus, such as one located at an analyzer 118A, 118B, and/or 118C.

Aspirating and dispensing apparatus 316 may aspirate and dispense biological samples (e.g., samples 236A and/or 236B), reagents, and the like into a reaction vessel to enable or facilitate analysis of the biological samples at one or more analyzer stations 118A-118C. Aspirating and dispensing apparatus 316 may include a robot 338 configured to move a probe assembly 340 within an aspirating and dispensing station. Probe assembly 340 may include a probe 340P configured to aspirate, e.g., a reagent 342 from a reagent packet 344, as shown. Probe assembly 340 may also be configured to aspirate a biological sample 336 from a sample container 302 (after its cap is removed, as shown), which is positioned at aspirating and dispensing apparatus 316 via, e.g., automated track 112. Reagent 342, other reagents, and a portion of sample 336 may be dispensed into a reaction vessel, such as a cuvette 346, by probe 340P. In some embodiments, cuvette 346 may be configured to hold only a few microliters of liquid. Other portions of biological sample 336 may be dispensed into other cuvettes (not shown) along with other reagents or liquids by probe 340P.

Operation of some or all components of aspirating and dispensing apparatus 316 may be controlled by a computer 320. Computer 320 may include a processor 320P and a memory 320M. Memory 320M may have software 320S stored therein that is executable on processor 320P. Software 320S may include algorithms that control and/or monitor positioning of probe assembly 340 and aspiration and dispensing of liquids by probe assembly 340. Software 320S may also include an algorithm 320A (which may alternatively be firmware) configured to detect a short-sample aspiration fault as described further below. In some embodiments, algorithm 320A may be an artificial intelligence (AI) algorithm. Computer 320 may be a separate computing/control device coupled to computer 120 (system controller). In some embodiments, the features and functions of computer 320 may be implemented in and performed by computer 120. Also, in some embodiments, the functions of probe assembly positioning and/or probe assembly aspiration/dispensing may be implemented in separate computing/control devices or in computer 120.

Robot 338 may include one or more robotic arms 342, a first motor 344, and a second motor 346 configured to move probe assembly 340 within, e.g., aspirating and dispensing station 116 of system 100. Robotic arm 342 may be coupled to probe assembly 340 and first motor 344. First motor 344 may be controlled by computer 320 to move robotic arm 342 and, consequently, probe assembly 340 to a position over a liquid container. Second motor 346 may be coupled to robotic arm 342 and probe assembly 340. Second motor 346 may also be controlled by computer 320 to move probe 340P in a vertical direction into and out of a liquid container for aspirating or dispensing a liquid therefrom or thereto. In some embodiments, robot 338 may also include one or more sensors 348, such as, e.g., vibration, electrical current or voltage, and/or position sensors, coupled to computer 320 to provide feedback and/or to facilitate operation of robot 338.

Aspirating and dispensing apparatus 316 may also include a pump 350 mechanically coupled to a conduit 352 and controlled by computer 320. Pump 350 may generate a vacuum or negative pressure (e.g., aspiration pressure) in conduit 352 to aspirate liquids, and may generate a positive pressure (e.g., dispense pressure) in conduit 352 to dispense liquids.

Aspirating and dispensing apparatus 316 may further include a pressure sensor 354 configured to measure aspiration and dispensing pressure in conduit 352 and to accordingly generate pressure data. The pressure data may be received by computer 320 and may be used to control pump 350. An aspiration pressure measurement signal waveform (versus time) may be derived by computer 320 from the received pressure data and may be input to algorithm 320A for detection of a short-sample aspiration fault in probe assembly 340 during an aspiration process. In those embodiments wherein algorithm 320A is an AI algorithm, aspiration pressure measurement signal waveforms derived from the received pressure data from pressure sensor 354 may also be used to train the AI algorithm to detect short-sample aspiration faults.

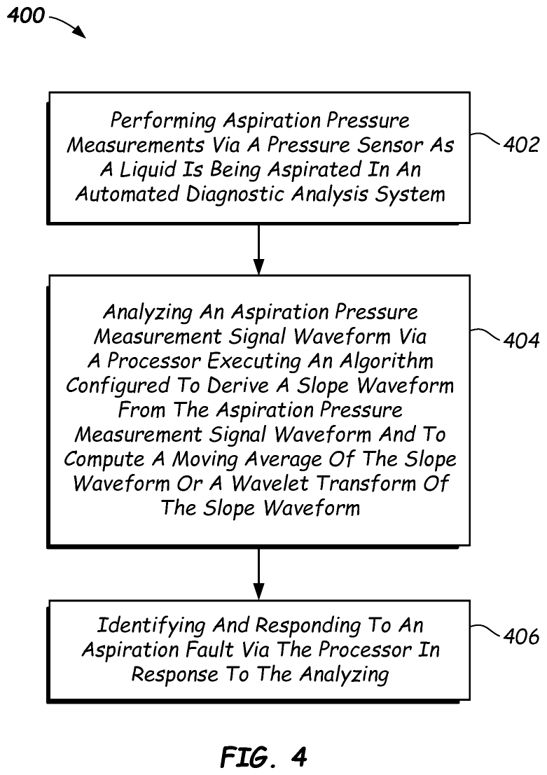

FIG. 4 illustrates a method 400 of detecting a short-sample aspiration fault in an automated diagnostic analysis system according to one or more embodiments. At process block 402, method 400 may begin by performing aspiration pressure measurements via a pressure sensor as a liquid is being aspirated in an automated diagnostic analysis system. For example, aspiration pressure measurements may be made by pressure sensor 354 of aspirating and dispensing apparatus 316 (of FIG. 3), which may be part of aspirating and dispensing station 116 of automated diagnostic analysis system 100 (of FIG. 1).

At process block 404, method 400 may include analyzing an aspiration pressure measurement signal waveform via a processor executing an algorithm configured to derive a slope waveform from the aspiration pressure measurement signal waveform and to compute a moving average of the slope waveform or a wavelet transform of the slope waveform.

Analyzing an aspiration pressure measurement signal waveform to detect a short-sample aspiration fault is based on distinct transient behavioral differences between pressure measurement signal waveforms of normal aspirations and abnormal aspirations (representing short-sample aspiration faults).

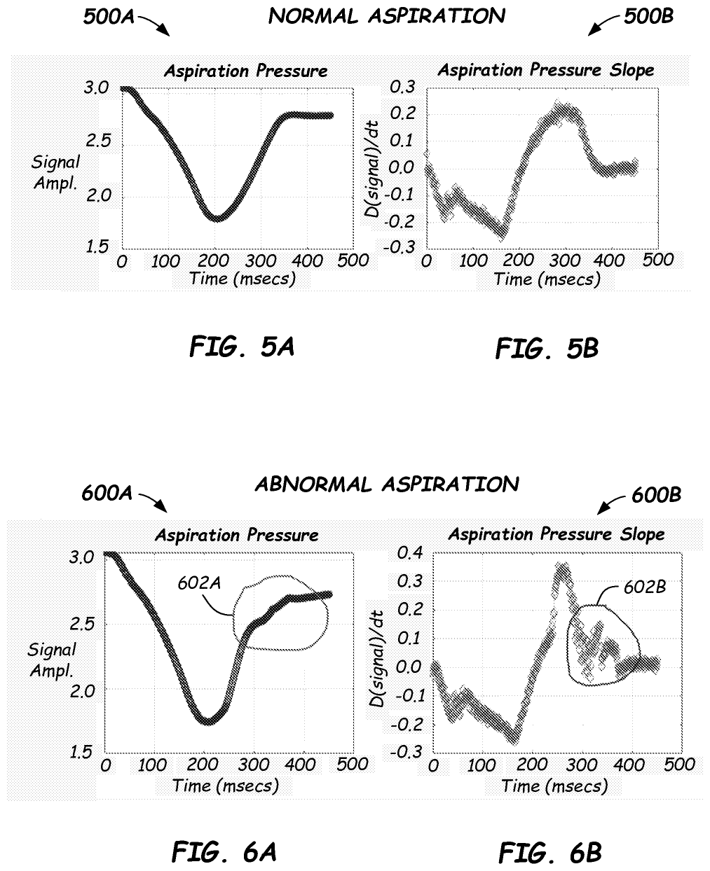

FIG. 5A illustrates a graph 500A of an aspiration pressure signal waveform versus time of a normal aspiration, and FIG. 5B illustrates a graph 500B of a slope waveform (i.e., a time-derivative of the pressure signal waveform-d (pressure signal)/dt) versus time of the aspiration pressure signal waveform of FIG. 5A according to one or more embodiments. In contrast, FIG. 6A illustrates a graph 600A of an aspiration pressure signal waveform versus time of an abnormal (short sample) aspiration, and FIG. 6B illustrates a graph 600B of a slope waveform (i.e., a time-derivative of the pressure signal waveform-d (pressure signal)/dt) versus time of the aspiration pressure signal waveform of FIG. 6A according to one or more embodiments. The aspiration pressure signal waveforms of graphs 500A and 600A may have been each generated by an aspirating and dispensing apparatus such as, e.g., aspirating and dispensing apparatus 316 (of FIG. 3), while the slope waveforms of graphs 500B and 600B may have been each derived by algorithm 320A from the respective aspiration pressure signal waveforms of graphs 500A and 600A. Note the circled portions 602A and 602B of graphs 600A and 600B, respectively, in comparison to the corresponding portions in graphs 500A and 500B, respectively. These differences are detectable by method 400.

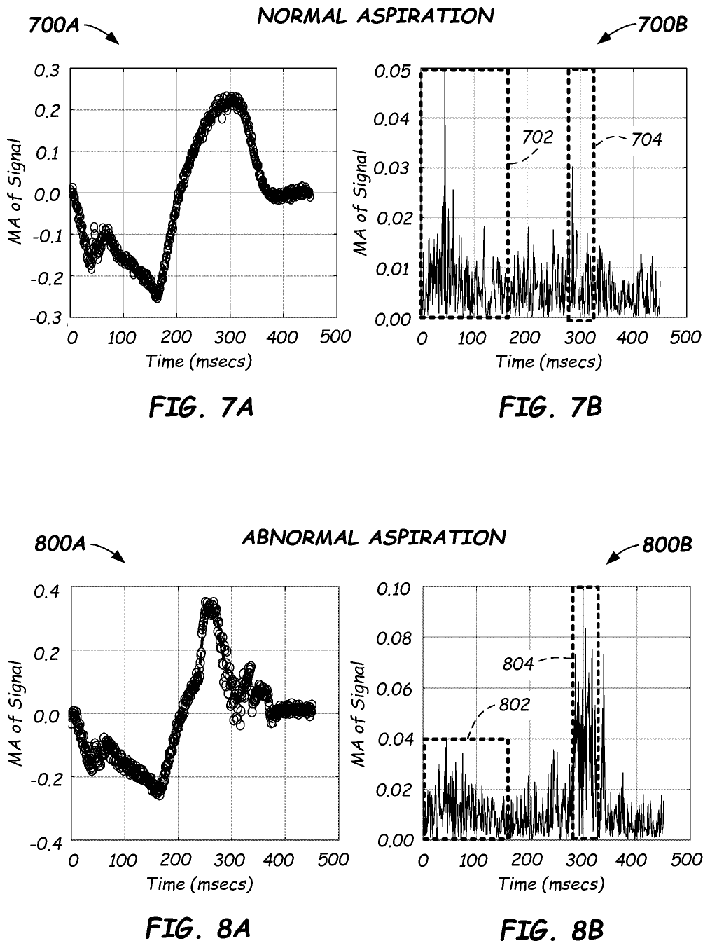

In some embodiments, after derivation of the slope waveform, process block 404 further includes analyzing the derived slope waveform via the processor executing the algorithm by computing a moving average of the slope waveform and then computing a difference between the moving average and the slope waveform at suitable time increments (e.g., every 10 msecs) during the aspiration process. These computed differences may be referred to as delta signals. The moving average may, in some embodiments, be based on a moving average window of about 10 msec (+/−10%). The analysis performed at process block 404 may continue by computing a noise floor amplitude, which in some embodiments, may be an RMS (root-mean-square) amplitude of the delta signals from t=0 to 150 msec of the aspiration process. One or more signal amplitude metrics (such as, e.g., mean of absolute, RMS, or 75^{th} percentile value) of the delta signals may be computed over a detection window, which in some embodiments, may be from 270-320 msecs into the aspiration process. An SNR may then be computed wherein SNR=20 log (signal_metric/noise) dB. FIGS. 7A-10 illustrate the above computations.

FIG. 7A illustrates a graph 700A of a moving average of a slope waveform (such as, e.g., graph 500B) representing normal aspiration, and FIG. 7B illustrates a graph 700B of delta signals based on the moving average graph 700A according to one or more embodiments. In some embodiments, the moving average is based on a moving average window of about 10 msec (+/−10%). Delta signal graph 700B may include a noise floor window 702 from t=0 to 150 msec within which delta signals may be used to compute a noise floor amplitude. Delta signal graph 700B may also include a detection window 704, which has been determined to be optimum in some embodiments from 270 to 320 msecs. Delta signals within detection window 704 are analyzed to determine whether an aspiration is normal or abnormal, as described in more detail below.

FIG. 8A illustrates a graph 800A of a moving average of a slope waveform (such as, e.g., graph 600B) representing abnormal (short sample) aspiration, and FIG. 8B illustrates a graph 800B of delta signals based on the moving average graph 800A according to one or more embodiments. The moving average is again based on a moving average window of about 10 msec (+/−10%), corresponding to the moving average window of the normal aspirations of FIG. 7B. Delta signal graph 800B may include a noise floor window 802 also from t=0 to 150 msec within which delta signals may be used to compute a noise floor amplitude. Delta signal graph 800B may also include a detection window 804, corresponding to detection window 704, which has been determined to be optimum in some embodiments from 270 to 320 msecs. Delta signals within detection window 804 are analyzed to determine whether an aspiration is normal or abnormal, as described in more detail below.

The determination of a suitable detection window and threshold for determining normal and abnormal aspirations may be based on analysis of test samples of known normal and abnormal aspiration pressure signal waveforms.

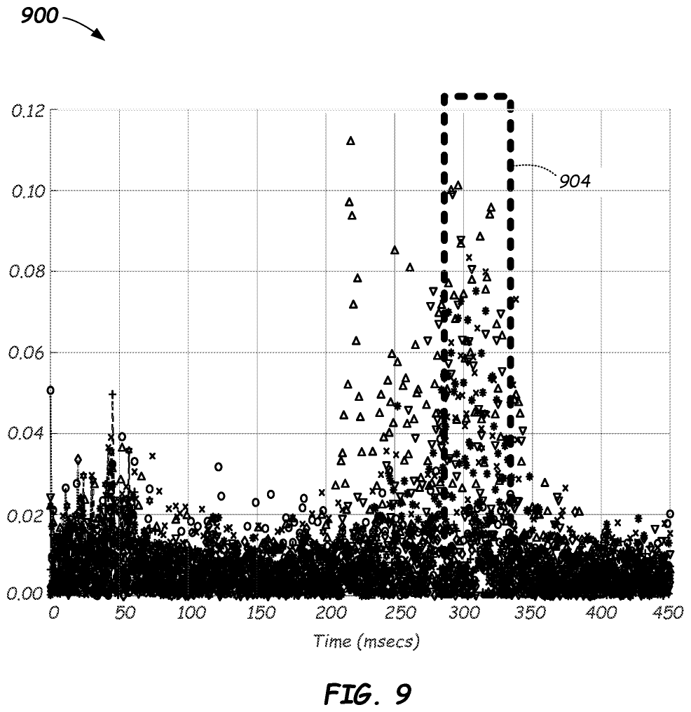

FIG. 9 illustrates a graph 900 of a plurality of delta signals based on the moving average of eight sample aspiration pressure signal waveforms according to one or more embodiments, wherein four are known to be normal aspirations and four are known to be abnormal aspirations (short-sample aspiration faults). The delta signals are based on a moving average window of about 10 msec (+/−10%). A detection window 904 has been optimally chosen to range from 270 to 320 msecs because only the abnormal aspirations show delta signal signatures therein.

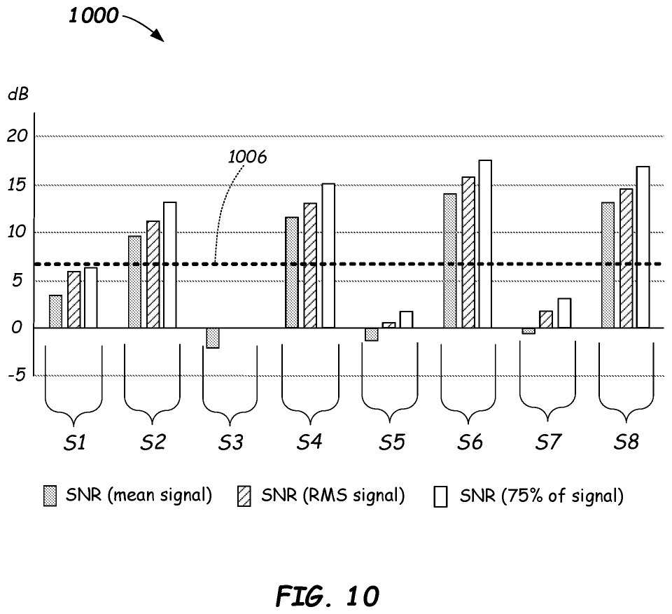

FIG. 10 illustrates a bar graph 1000 of SNR versus SNR metrics (mean of absolute, RMS, and 75^{th} percentile value) according to one or more embodiments for the delta signals of FIG. 9, which represent the eight-sample aspiration pressure signal waveforms S1, S2, S3, S4, S5, S6, S7, and S8. The computed SNR (=20 log (signal_metric/noise) dB for samples S1, S3, S5, and S7 represent normal aspirations, while the computed SNR for samples S2, S4, S6, and S8 represent abnormal aspirations. Accordingly, an SNR threshold 1006 of 7 dB may be selected, wherein an SNR below 7 dB indicates a normal aspiration and an SNR at and above 7 dB indicates an abnormal aspiration (a short-sample aspiration fault). SNR threshold 1006 represents a clear demarcation between normal and abnormal aspirations.

In some embodiments where algorithm 320A is an AI algorithm, an unsupervised learning method such as, e.g., K-means clustering may be used to identify abnormal aspirations in pressure slope waveforms. AI algorithm 320A, which is executable by processor 320P, may be implemented in any suitable form of artificial intelligence programming including, but not limited to, neural networks, including convolutional neural networks (CNNs), deep learning networks, regenerative networks, and other types of machine learning algorithms or models. Note, accordingly, that AI algorithm 320A is not, e.g., a simple lookup table. Rather, AI algorithm 320A may be trained to detect or predict one or more types of aspiration faults and is capable of improving (making more accurate determinations or predictions) without being explicitly programmed.

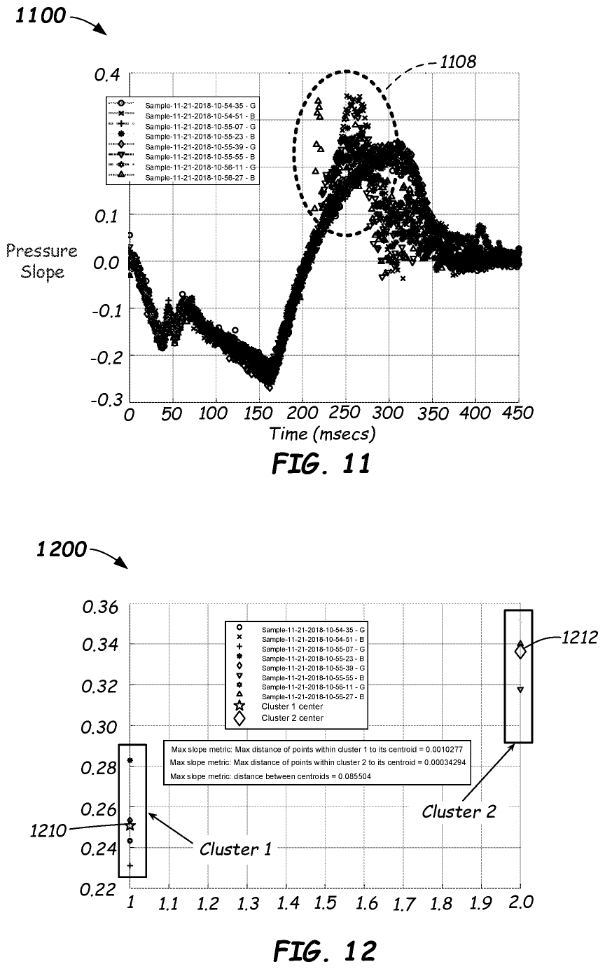

FIG. 11 illustrates a graph 1100 of pressure slope versus time of eight test sample aspiration pressure signal waveforms according to one or more embodiments. Four test sample aspiration pressure signal waveforms represent normal aspirations, and four test sample aspiration pressure signal waveforms represent abnormal (short sample) aspirations. The abnormal aspirations show larger magnitudes of pressure slope than the normal aspirations (see encircled region 1108). Accordingly, this “max-slope” metric may be used with K-means clustering to identify abnormal aspirations. That is, the maximum slope of the pressure slope waveform may be interrogated over the entire aspiration process to classify the aspiration as normal or abnormal (i.e., a short sample). FIG. 12 illustrates a graph 1200 of a two-cluster classification of the max-slope metric of the eight test sample aspiration pressure signal waveforms according to one or more embodiments (wherein the X-axis represents time in milliseconds and the Y-axis represents pressure slope, which is the rate of change of normalized pressure over time). As shown, Cluster 1 (having center 1210) and Cluster 2 (having center 1212) are well separated, indicating that the max-slope metric is well suited for unsupervised (K-means clustering) classification of normal and abnormal (short sample) aspirations.

Note that other unsupervised clustering methods may be used instead of K-means clustering. Also, in cases where the samples can be labeled beforehand, supervised classification methods such as logistic regression, SVMs (Support Vector Machines), Bayesian classifiers, etc., may be used.

Returning to process block 404, method 400 may alternatively include analyzing an aspiration pressure measurement signal waveform via a processor executing an algorithm configured to derive a slope waveform from the aspiration pressure measurement signal waveform by computing a wavelet transform of the slope waveform. As discussed above in connection with the moving average slope waveforms of FIG. 7A (representing normal aspiration) and FIG. 8A (representing abnormal (short sample) aspiration), distinct differences in the spectral signature between the two waveforms are observable. The powerful simultaneous time-scale (frequency) localization and multi-resolution analysis capabilities of wavelets are advantageously employed in this analysis. The wavelet transform may be a continuous wavelet transform (CWT) or a discrete wavelet transform (DWT).

An overview of an analysis using a CWT may include computing a pressure slope waveform from an aspiration pressure measurement signal waveform by differencing the pressure signal, as described above. Suitable moving average filters may be used for reducing amplification of noise due to differentiation. The analysis may also include computing in real time the CWT of the pressure slope signal over sliding time windows as follows:

$${W}_{ψ} s ( a , b ) = \frac{1}{\sqrt{a}} {\int }_{- ∞}^{+ ∞} s ( x ) ψ ( \frac{b - x}{a} ) dx$$

wherein “a” is a scale parameter and “b” is a shift parameter.

The analysis may further include interrogating the CWT coefficients at specific ranges of scales and then differentiating faulty aspirations from normal ones by computing suitable metrics based on the identified CWT coefficients and applying suitable (identified) thresholds.

In some embodiments, computing suitable metrics may include determining a baseline signal as follows: compute the total CWT energy in a suitable scale range (which in this case has been determined to be, e.g., <13) and over a time window from 0 to t₀ (which in this case has been chosen to be, e.g., t₀=125 msecs). Next, compute CWT energy within the same scale range (<13) at every time-step or at sub-sampled time-steps for a detection window t>200 msecs (determined as described below), and then compute the detection SNR metric as:

$$SNR = 20 {log}_{10} ( \frac{CWT energy ( t > 200 msecs )}{Baseline CWT energy} )$$

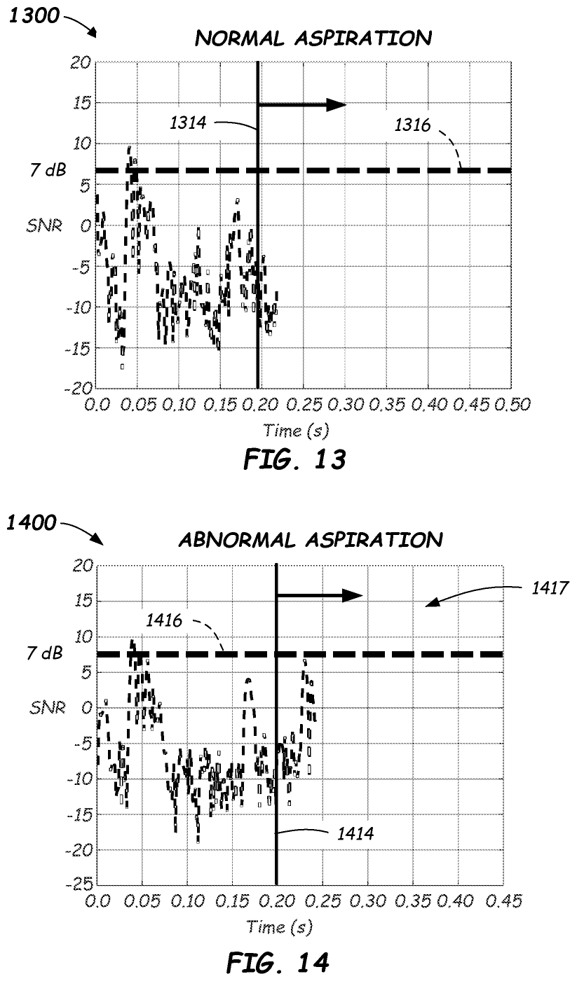

FIG. 13 illustrates a graph 1300 of CWT SNR metrics versus time for a normal aspiration sample, and FIG. 14 illustrates graph 1400 of CWT SNR metrics versus time for an abnormal aspiration sample, each according to one or more embodiments. Based on the resulting CWT SNR metrics in graphs 1300 (for a normal aspiration sample) and 1400 (for an abnormal aspiration sample), a suitable detection window 1314 and 1414 of t>200 msecs may be chosen, and a suitable SNR metric threshold 1316 and 1416 of 7 dB may be chosen. As shown by the area indicated by arrow 1417, which shows SNR metric values exceeding threshold 1416 in detection window 1414, these CWT SNR metrics are suitable for detecting abnormal (short sample) aspirations. To maximize classification accuracy, additional normal and abnormal aspiration sample data may be used to identify appropriate detection windows and CWT SNR thresholds.

In some embodiments of the CWT analysis, the following options may be considered:
the scale “a” and shift “b” parameters may be restricted to discrete values and specifically to a dyadic representation where the scale parameter is restricted to powers of 2.
Mallat's algorithm or Shensa's algorithm with a dyadic representation of the scale parameter may be used. This may have O (N) computational complexity, where N=length of signal vector. In actual detection, only a signal for t>200 msecs may be considered, and thus N would be relatively small.
If finer discretization of the scale “a” parameter is required (e.g., “a”=integer values that need not be powers of 2), then other methods such as the spline representation-based fast CWT transform algorithms, such as in Unser et. al, IEEE Trans on Signal Proc., 1994, may be used. These may also have O (N) computational complexity.
Detection thresholds, suitable range of scales, measures for a baseline signal, as well as the detection and baseline signal time-windows may be tuned further by examining a larger data set of normal and abnormal aspiration signal samples.
Similarly, the type of wavelet to use may also be chosen optimally through further examination of more aspiration signal samples.
One of the wavelet types found suitable for use in this analysis may be the Symlet 2 wavelet. However other suitable CWT types may be used.
The wavelet filters may be implemented using firmware or data manipulation language (DML)-level software and may be implemented on FPGAs (field programmable gate arrays), DSP (digital signal processor) chips, or other suitable ICs (integrated circuits).

In other embodiments, analysis of an aspiration pressure measurement signal waveform may include using a DWT. An advantage of using DWT may be its low computational cost and efficacy in detecting transients (usually at lower scales) using its multi-resolution analysis capabilities. An overview of an analysis using a DWT may include computing a pressure slope waveform from an aspiration pressure measurement signal waveform by differencing the pressure signal, as described above. Suitable moving average filters may be used for reducing amplification of noise due to differentiation. The analysis may also include computing in real time the DWT of the pressure slope signal over sliding time windows, interrogating the DWT coefficients at specific ranges of scales, and differentiating faulty aspirations from normal ones by computing suitable metrics based on the identified DWT coefficients and applying suitable (identified) thresholds.

More particularly, a DWT analysis may include determining a baseline signal as follows: compute the maximum DWT norm (largest coefficient value) in a suitable scale range (which in this case has been determined to be, e.g., <2) and over a time window from 0 to t₀ (which in this case has been chosen to be, e.g., t₀=125 msecs). Next, compute “DWT max norm” within the same scale range (<2) at every time-step or at sub-sampled time-steps for a detection window t>200 msecs (determined as described below), and then compute the detection SNR metric as:

$$SNR = 20 {log}_{10} ( \frac{DWT norm ( t > 200 msecs , max ( {a}_{1} < a < {a}_{2} ) )}{Baseline DWT norm} )$$

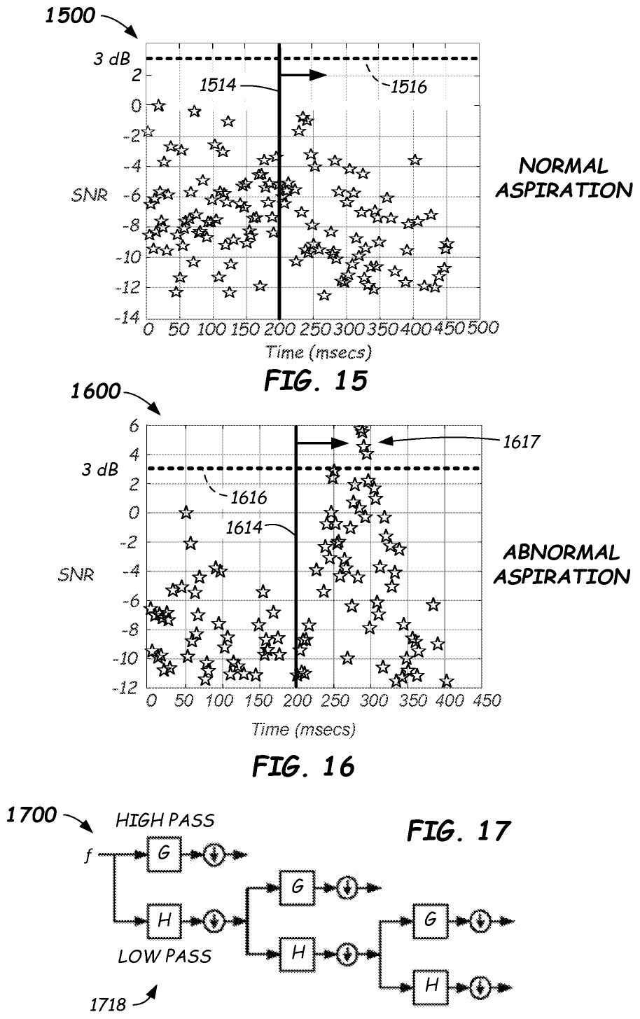

FIG. 15 illustrates a graph 1500 of DWT SNR metrics versus time for a normal aspiration sample, and FIG. 16 illustrates graph 1600 of DWT SNR metrics versus time for an abnormal aspiration sample, each according to one or more embodiments. A clear distinction in DWT SNR metrics is observed between normal and abnormal aspiration samples for t>200 msecs at lower scales (scales=1 to 2). That is, the DWT SNR metrics for the normal aspiration sample shown in FIG. 15 (and for several other normal aspiration samples also tested as described herein) have been consistently less than 0 dB. In contrast, the DWT SNR metrics for the abnormal aspiration sample shown in FIG. 16 (and for several other abnormal aspiration samples also tested as described herein) have been consistently at least or greater than 4 dB for at least one time instance for t>200 msecs. Based on these results, a suitable detection window 1514 and 1614 of t>200 msecs may be chosen, and a suitable DWT SNR metric threshold 1516 and 1616 of 3 dB may be chosen. (see, e.g., the area indicated by arrow 1617, which shows DWT SNR metric values for an abnormal aspiration sample exceeding threshold 1616 in detection window 1614). To maximize detection accuracy, additional normal and abnormal aspiration sample data may be used to identify appropriate detection windows and DWT SNR thresholds.

FIG. 17 illustrates a schematic of a multi-level DWT filter bank 1700 that may be used to implement the DWT analysis described above according to one or more embodiments. DWT filter bank 1700 may be a cascaded filter bank including separate high and low pass filtering and down-sampling operations at each level, where “G” represents a high-pass filter and, at each step, provides the “detail” of the signal at that scale, and “H” represents a low-pass filter. At each stage, the output of the H filtering is subsampled by half and proceeds through a next stage of wavelet filtering in the cascaded filter bank. In some embodiments, the DWT analysis described herein may require nine levels (note only three are shown in FIG. 17). However, because the lowest-scale DWT components are used to detect the transients in the pressure slope signal (and consequently abnormal aspirations), a complete analysis of the pressure slope signal at every time step may not be needed. DWT computations may thus only need to be performed by the first level 1718 of DWT filter bank 1700. This advantageously may result in significant computational run-time savings, which may allow for minimal firmware or software overheads. In some embodiments, the Symlet 2 or Daubechies order-2 and order-4 wavelets may be used. These may be implemented as simple 2^{nd} or 4^{th} order low-pass and high-pass filters as shown in FIG. 17.

Returning to FIG. 4, method 400 may continue at process block 406 by identifying and responding to an aspiration fault (i.e., a short-sample aspiration fault) via the processor in response to the analyzing performed at process block 404. As described above, a short-sample aspiration fault may be identified via a spectral analysis by computing a moving average, a conventional band-pass filter (such as, e.g., a Butterworth filter), a CWT, or a DWT. Each of these analyses are capable of accurately detecting a short-sample aspiration fault by the end of an aspiration process. Method 400 may respond to an identified short-sample aspiration fault by timely terminating an analysis of a liquid (involved in the short-sample aspiration fault) by the automated diagnostic analysis system prior to commencement of any analysis of the liquid. In other embodiments, method 400 may respond to an identified short-sample aspiration fault by alternatively or additionally implementing system one or more other procedures for an error state.

The three spectral analyses (moving average, CWT, and DWT) each include real-time computations performed on portions of an aspiration pressure signal waveform, thus advantageously limiting the size of the data stream analyzed at each time step. Each has an O (N) computational cost, thereby making online implementation of these analyses in firmware or software using DSP (digital signal processor) microchips or FPGAs (field programmable gate arrays) feasible.

While this disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure or the following claims.

What is claimed is:

1. A method of detecting a short-sample aspiration fault in an automated diagnostic analysis system, the method comprising:
performing aspiration pressure measurements via a pressure sensor as a liquid is being aspirated in the automated diagnostic analysis system;
analyzing an aspiration pressure measurement signal waveform via a processor executing an algorithm configured to derive a slope waveform from the aspiration pressure measurement signal waveform and to compute:
a moving average of the slope waveform, or
a wavelet transform of the slope waveform; and
identifying and responding to a short-sample aspiration fault via the processor in response to the analyzing.

2. The method of claim 1 wherein the algorithm configured to compute the moving average is further configured to compute a difference between the moving average and the slope waveform at pre-determined time increments within a detection window of the slope waveform.

3. The method of claim 1, wherein the algorithm configured to compute the moving average is further configured to compute a signal-to-noise ratio equal to 20 log (signal_metric/noise) dB, wherein the signal_metric comprises at least one of a mean of absolute, root-mean-square (RMS), or 75^{th} percentile value of differences between the moving average and the slope waveform at pre-determined time increments within a detection window of the slope waveform.

4. The method of claim 1 wherein the identifying and responding further comprises identifying and responding to an aspiration fault via the processor by determining whether a signal-to-noise ratio exceeds a threshold.

5. The method of claim 1 wherein the moving average is based on a moving average window of about 10 msec.

6. The method of claim 1 wherein the wavelet transform is a continuous wavelet transform (CWT) or a discrete wavelet transform (DWT).

7. The method of claim 1 wherein the algorithm configured to compute the wavelet transform is further configured to compute a plurality of metrics of the wavelet transform based on wavelet transform coefficients.

8. The method of claim 7 wherein the identifying and responding further comprises identifying and responding to an aspiration fault via the processor by determining whether a signal-to-noise ratio exceeds a threshold.

9. The method of claim 1 wherein the analyzing the aspiration pressure measurement signal waveform occurs during a detection window ranging from 270 msec to 320 msec of commencement of an aspiration process.

10. The method of claim 1 wherein the identifying and responding comprises terminating an analysis of the liquid by the automated diagnostic analysis system prior to commencement of the analysis of the liquid in response to identifying a short-sample aspiration fault.

11. An automated aspirating and dispensing apparatus, comprising:
a robotic arm;
a probe coupled to the robotic arm;
a pump coupled to the probe;
a pressure sensor configured to perform aspiration pressure measurements as a liquid is being aspirated via the probe; and
a processor configured to execute an algorithm to detect and respond to a short-sample aspiration fault during an aspiration process, the algorithm configured to analyze an aspiration pressure measurement signal waveform received from the pressure sensor by deriving a slope waveform from the aspiration pressure measurement signal waveform and performing a spectral analysis of the slope waveform by computing a moving average or a wavelet transform of the slope waveform.

12. The automated aspirating and dispensing apparatus of claim 11, wherein the algorithm is further configured to compute a difference between the moving average and the slope waveform at pre-determined time increments within a detection window of the slope waveform.

13. The automated aspirating and dispensing apparatus of claim 11, wherein the algorithm is further configured to compute a plurality of metrics of the wavelet transform based on wavelet transform coefficients.

14. The automated aspirating and dispensing apparatus of claim 11, wherein the algorithm is further configured to detect and respond to a short-sample aspiration fault during an aspiration process by determining whether a signal-to-noise ratio exceeds a threshold.

15. The automated aspirating and dispensing apparatus of claim 11, wherein the wavelet transform is a continuous wavelet transform (CWT) or a discrete wavelet transform (DWT).

16. The automated aspirating and dispensing apparatus of claim 11, wherein:
the moving average is based on a moving average window of about 10 msec; or
the algorithm configured to perform the spectral analysis of the slope waveform is further configured to perform the spectral analysis of the slope waveform by computing the moving average during a detection window ranging from 270 msec to 320 msec of commencement of an aspiration process.

17. The automated aspirating and dispensing apparatus of claim 11, wherein the algorithm is an artificial intelligence (AI) algorithm further configured to perform automated classification of normal and abnormal (short-sample) classification by determining normal/abnormal thresholds using a trained learning-based classifier.

18. The automated aspirating and dispensing apparatus of claim 11, wherein the processor executing the algorithm is configured to respond to a short-sample aspiration fault during the aspiration process by terminating an analysis of the liquid by the automated diagnostic analysis system.

19. An automated diagnostic analysis system, comprising:
the automated aspirating and dispensing apparatus of claim 11;
one or more analyzer stations for analyzing a biological sample; and
an automated track for transporting sample containers and reaction vessels to and from the automated aspirating and dispensing apparatus and the one or more analyzer stations.

20. A non-transitory computer-readable storage medium, comprising a processor-executable algorithm configured to detect a short-sample aspiration fault based on spectral analysis of a pressure slope waveform derived from an aspiration pressure measurement signal waveform, the algorithm configured to perform the spectral analysis of the pressure slope waveform by computing a moving average or a wavelet transform of the pressure slope waveform.

21. A method of detecting a short-sample aspiration fault in an automated diagnostic analysis system, the method comprising:
deriving an aspiration pressure measurement signal waveform from aspiration pressure measurements made by a pressure sensor as a liquid is being aspirated in the automated diagnostic analysis system;
identifying a pattern in one or more first aspiration pressure measurement signal waveforms of normal aspirations;
defining a time-windowed localization of an aberration identified in one or more second aspiration pressure measurement signal waveforms, the aberration caused by the short-sample aspiration fault; and
deriving suitable discriminating metrics to detect the aberration, wherein simple thresholding, an unsupervised classifier, or a supervised learning-based classifier is used with the discriminating metrics to identify the aberration in subsequent aspiration pressure measurement signal waveforms.
